(19) United States
(12) Patent Application Publication
(10) Pub. No.: US 2017/0339852 A1
(43) Pub. Date: Nov. 30, 2017

(54) WATERING SYSTEM

(71) Applicant: Smart Rain Systems, LLC, Centerville, UT (US)

(72) Inventor: Rudy Lars Larsen, Bountiful, UT (US)

(21) Appl. No.: 15/165,482

(22) Filed: May 26, 2016

(51) Int. Cl. A01G 25/16; G05B 15/02

(52) U.S. Cl. CPC A01G 25/16; A01G 25/165; G05B 15/02

(57) ABSTRACT

A system and method for providing watering services is disclosed. The system may include a plurality of controllers, where each controller controls application of water by a watering system associated with the controller. A cloud based platform may be accessed by a user, or property owner, from a computerized device that is remote from each of the controllers. The computerized device may be in communication with the cloud based platform and may be configured to implement commands issued by user to the watering system. The system may also detect faults in the watering systems using water usage data from the controllers and a user may implement automatic or manual commands to control or handle such faults.

### CROSS-REFERENCE TO RELATED APPLICATIONS

This application incorporates the following patents or applications, in their entirety, by reference: U.S. patent application Ser. No. 13/899,544 titled IRRIGATION MANAGEMENT.

### TECHNICAL FIELD

This disclosure relates generally to a watering system, and more specifically to systems and methods for providing water systems and services of one or more facilities either at the location or remotely and allows users of a computer system to use the method and system to adequately and efficiently apply enough water to a landscape.

### BACKGROUND OF RELATED ART

Water is becoming an increasingly scarce resource. This increasing scarcity is pressuring consumers and governments alike to consider how they use water and how they can use it more wisely. The costs of water are also increasing as a result of scarcity, and businesses are under pressure to reduce costs associated with using water.

Many businesses and users need water to maintain the grounds of their business facilities and their residences. Some estimates posit that landscape irrigation accounts for nearly one-third of all residential water use, and totals almost nine billion gallons per day. Much of that water is wasted due to inefficient irrigation methods and systems.

As a result, water users are looking for options to reduce water usage without negatively impacting their landscape. However, doing so often requires expertise in landscape irrigation and may require expensive equipment. Furthermore, some water users are unsure whether they will ever recoup the investment they make in the system. Many water users forgo the benefits of more sophisticated irrigation systems and waste water as a result.

### BRIEF SUMMARY OF THE INVENTION

Disclosed herein is a method and system for providing a user the ability to manage and service a landscape with an irrigation system or watering system. In one embodiment a user will use a computer readable medium to utilize software to apply changes to a system, more specifically a watering or irrigation system, which may include increased or decreased watering times; allow a user to view water usage and costs against water budgets and adjust the watering to meet budgets and targets; turn zones within a watering system off and on; and other possible manipulations in a watering system.

The method and system may require a computer, tablet, cell phone or other computing device and a compatible watering system. The system may be communicated with through Wi-Fi, Ethernet, cellular communication, radio frequency or the like in order for the system and method to function property. The method and system may include automatic correction and/or customizable correction of watering and irrigation. The system and method may utilize and communicate with weather outlets and forecasters to adequately provide enough water or moisture to the landscaped area. The system may manually, automatically or be customized to adjust watering to the weather forecast or the current weather.

The system may be maintained on a platform that is either on the cloud, or physically housed in a separate location, or at the location of the watering system. The system may provide notifications to the user based on weather, water output, water usage, budgetary restrictions, water allotment restrictions or other notifications related to evapotranspiration (“ET”).

The system and method may also involve dynamically adjusting watering system remotely on factors such as forecasted rain, forecasted temperatures, high winds, and other weather-related events that may affect the watering system and facilitate water conservation.

Other aspects, as well as features and advantages of various aspects, of the present system and method will become apparent to those of skill in the art though consideration of the ensuing description, the accompanying drawings and the appended claims.

### BRIEF DESCRIPTION OF THE DRAWINGS

FIG. 1 illustrates an embodiment of a watering management system;

FIG. 2 is a block diagram of an embodiment of a watering system having a controller;

FIG. 3 is a schematic block diagram illustrating one embodiment of a watering system with a master valve and flow sensor; and

FIG. 4 is a flow chart diagram illustrating one embodiment of a method for managing a watering system remotely.

### DETAILED DESCRIPTION

Referring in general to the accompanying drawings, various embodiments of the present invention are illustrated to show the system and methods for a watering system. It should be understood that the figures presented are for illustrative purposes solely and do not represent actual views of any particular portion of the actual embodiment structure, but are merely schematic representations which are provided to more clearly and fully depict embodiments of the system and method.

The following provides a more detailed description of ways to implement the present system and method and various representative embodiments thereof. In this description, functions may be shown in block diagram form in order not to obscure the present disclosure in unnecessary detail. It will be readily apparent to one of ordinary skill in the art that the present invention may be practiced by numerous other solutions.

In this description, some drawings may illustrate signals as a single signal for clarity of presentation and description. It will be understood by a person of ordinary skill in the art that the signal may represent a bus of signals, wherein the bus may have a variety of bit widths and the present invention may be implemented on any number of data signals including a single data signal.

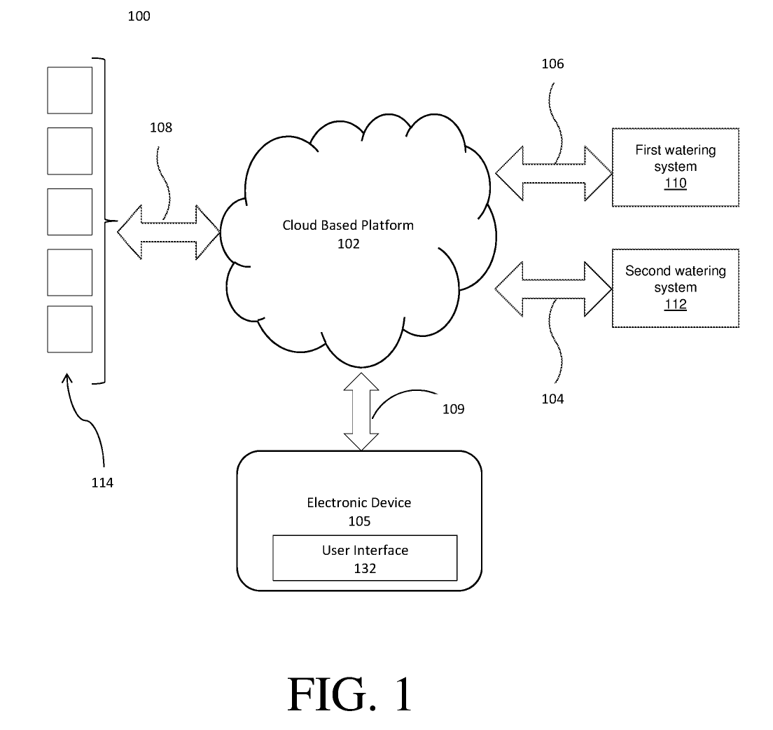

FIG. 1 illustrates an irrigation or water management system 100 for remotely managing one or a plurality of watering systems. The watering management system 100 includes a cloud based platform 102, or central computer, in communication with a single or a plurality of individual, remotely located watering systems 110, 112, 114. Each watering system 110, 112, 114 may include a controller for controlling the application of water by the watering system 110, 112, 114 at one or more stations corresponding to a particular portion or area of the watered landscape. Each watering system may be controlled by the owner, leaser or other supervisor of the landscape. While each specific watering system may include its own controller each controller receives signals, either wired or wirelessly, from a central computer or cloud based platform 102 to perform certain functions via the software interface or user interface 132.

The cloud based platform 102 may be a server accessible using the Internet or a system accessing the cloud using the Internet. While FIG. 1 illustrates the cloud based platform 102 as a single computing device, in certain embodiments, running software to execute the irrigation of a landscape. The cloud based platform 102 may play host to a plurality of watering systems each with their specific parameters for watering while not requiring a specific cloud based platform or server for each different watering system and access is only granted to those specific users needing access to their property while not having access to other's watering systems. However, it will be appreciated that a plurality of separate computing devices working together may provide the features described herein. In another embodiment, the cloud based platform 102 is a desktop computing device running software to implement the methods described herein.

The cloud based platform 102 once accessed may include the user interface 132 that allows users to access one or more functions of the watering system. The user interface 132 may be a graphical user interface (GUI) that runs on the cloud based platform 102 and allows a user to interact with the cloud based platform 102 through an electronic device 105, which may be a computer, tablet, phone or other computing device that may have wired or wireless access to the cloud based platform 102 via a communication link 109. The user interface 132 may also include one or more application programming interface (APIs) that allows one or more computer programs to access the functionality of the cloud based platform 102.

The cloud based platform 102 may store specific information about each watering system 110, 112, 114. Such information may include specific information about each station in the watering system (e.g., the type(s) of valves, the number and type(s) of sprinkler heads on each station, etc.). In addition, the cloud based platform 102 may store information on the area, topography and type(s) of landscaping covered by each station of the irrigation system 110, 112, 114.

The cloud based platform 102 may also communicate with one or more watering systems 110, 112, 114. The watering systems 110, 112, 114 may include controllers within each watering system 110, 112, 114, the controllers communicating with the watering system 110, 112, 114 itself or the controllers may communicate with the cloud based platform 102 itself. The watering system 110, 112, 114 communicates with the cloud based platform 102 using communications links 104, 106, 108. The communications links 104, 106, 108 may be wired communications links (such as telephone, or Ethernet connections), wireless communications links (such as Wi-Fi, cellular, or other), or a combination thereof. The controllers may communicate information with the watering system 110, 112, 114 which then may relay that information to the cloud based platform 102 using an appropriate communications protocol such as TCP/IP. Each controller may communicate water flow information from each station of the watering system 110, 112, 114. In addition, the cloud based platform 102 may be configured to receive information about the amount(s) of non-irrigation water (e.g., precipitation, water from nearby sources, etc.) to which one or more parts of the landscape to which each station of the watering system corresponds is exposed. Such information may be collected in any suitable manner known in the art (e.g., with automated rain sensors, etc.). The information, after gathered, is implemented into the software which executes commands or executes questions for the user to interact with to either automatically or manually adjust the watering system based on the new criteria.

In some embodiments, the cloud based platform 102 may also collect climate information which integrates into the software to execute certain protocols based on the information gathered. The climate information may include weather forecast information (e.g., temperatures at various times of the day, humidity forecast, cloud cover forecast, precipitation forecast, etc.) and/or real-time weather data (e.g., current temperature, current humidity, current cloud cover, current precipitation and up-to-date precipitation levels, etc.). Other types of information may also be stored and/or collected by the cloud based platform 102.

The software in cloud based platform 102 may be programmed, by a user or by the installer, implemented through the controller, to monitor irrigation at one or more stations of a remote watering system 110, 112, 114. Irrigation monitoring may include receipt of a flow signal from a monitored station and/or a monitored irrigation system 110, 112, 114. When flow information used in conjunction with information about the types of sprinkler heads or other components of that station, the software of the cloud based platform 102 may determine the amount of irrigation (i.e., volume of water) applied by that station and then relay that information to the user or store that information for the user once the user accesses the cloud based platform 102. When considered in conjunction with an optimal irrigation level (which may determined by a landscape professional and input into the computer, the cloud, etc. and in some embodiments, modified based on other criteria, such as recent, current or forecast weather, etc.) for that station, the software may run through predetermined execution pathways within the cloud based platform 102 and may determine how the actual amount of irrigation applied by the station compares to the optimal irrigation level programmed for that landscape. In some embodiments, real-time irrigation monitoring may occur and, when the optimal irrigation level by a particular station is reached, the software within the cloud based platform 102 may execute a termination signal terminating irrigation by that station and notification may be sent to a user or stored for when the user accesses the cloud based platform 102. In other embodiments, any discrepancy, or any discrepancy beyond acceptable ranges, may then be output by the software, used by the cloud based platform 102, to calculate execute a recommendation on modification of at least one future irrigation program for that station (e.g., if overwatering has occurred, reduce the next watering time, etc.) and/or used by the software of the cloud based platform 102 to calculate and automatically modify at least one future irrigation program for that station.

In addition, software within the cloud based platform 102 may be configured to provide an output indicative of potential problems with a monitored irrigation system, or a station of a monitored irrigation system 110, 112, 114. For example, if the software within the cloud based platform 102 determines that the amount of irrigation applied to landscaping by a particular station of a monitored irrigation system 110, 112, 114 exceeds irrigation that would have been applied if the station were operating normally, the software may be programmed to output a warning that there may be a leak, a bad sprinkler head or other component, or some other problem with that station as determined by the installer and/or user. Similarly, the software within the cloud based platform 102 may be programmed to execute a signal to a user warning if a flow sensor associated with a particular station continues to monitor water flow while the station is supposed to be turned off, as continued water flow may be indicative of a faulty valve. Similarly, a user may program the software on the cloud based platform to execute a termination signal if any of the signals mentioned above is received by the cloud based platform.

In addition, the cloud based platform 102 may collect information external to operation of a monitored irrigation system, such as weather or other climate information, evaporation information, transpiration information, or the like. With that external information, the software in the cloud based platform 102 may execute programs to adjust or modify a preprogrammed optimal irrigation amount and/or to determine and output and/or automatically implement modifications to programming for the monitored irrigation system 110, 112, 114.

The software in the cloud based platform 102 may also be configured to implement an irrigation management plan that includes irrigation programs for each of the stations in the watering system. The irrigation management plans may be unique to each watering system 110, 112, 114. In other embodiments, the irrigation management plans for like watering systems (i.e., those with similar landscapes) are the same. The software of the cloud based platform 102 may communicate the irrigation management plan to the controllers for each of the irrigation systems 110, 112, 114, which controls then implement the irrigation management plan at the location.

The user may log in to the cloud based platform 102 via any computer, laptop, tablet or smart phone or the like. Logging into the cloud based platform 102 may enable a user to manipulate the settings and change controls of the watering system, implement a new irrigation plan or any other variation. The user, after logging in, may also be able to permit other users to access the watering system(s) on the cloud based platform 102 to allow multiple users the ability to manipulate the watering system. Access to the cloud based platform 102 may be provided on a recurring basis by a user paying a fee daily, weekly, monthly, yearly or the like. The access to the system allows the user to always have control of the watering system with the latest updates to the software on the cloud based platform 102.

In addition to including a cloud based platform 102 and a plurality of remote irrigation systems 110, 112, 114, a watering system of the present embodiment may include one or more mobile devices that communicate with the cloud based platform 102. Each mobile device may comprise a portable electronic device of a type known in the art, such as a smart phone, a tablet computer, or the like. The mobile device may access the cloud based platform and display notifications requested by the user regarding each monitored irrigation system 110, 112, 114 from the cloud based platform 102 and, in some embodiments (including embodiments where the cloud based platform 102 automatically controls the monitored watering systems 110, 112, 114 and embodiments where the cloud based platform 102 does not automatically control the monitored watering system 110, 112, 114), to enable remote control over each monitored watering system 110, 112, 114 either through the cloud based platform 102 or directly.

In one embodiment, applications for mobile devices may also be configured to receive reports from the cloud based platform 102. For example, the property owner may have a mobile device with an application for receiving reports concerning water usage from the cloud based platform 102. Where the property owner has multiple properties to manage a single access to the cloud based platform 102 can allow the user to access each location with a single device and single recurring fee. The property owner may be able to consolidate reports, notifications, alerts and the like for the multiple properties.

In another embodiment, the user may be able to enter commands for the controller into the application, which commands are sent to the controller 202. The user may be able to override the irrigation management plan using the application. The user may, for example, cause the controller 202 to perform extra watering for a particular station using the application on the mobile device. The application may be configured to send information concerning water usage above the irrigation management plan originating from the user to the cloud based platform 102. The cloud based platform 102 may track the amount of water outside of the irrigation management plan applied at the client's direction. The cloud based platform 102 may report such usage to the user or an irrigation manager, who can take such information into account in determining the cost effect of user-directed watering. An “irrigation manager” is an individual who may install, service and program the watering system for a user. The cloud based platform 102 may similarly track user-directed watering events that are initiated from the controller 202.

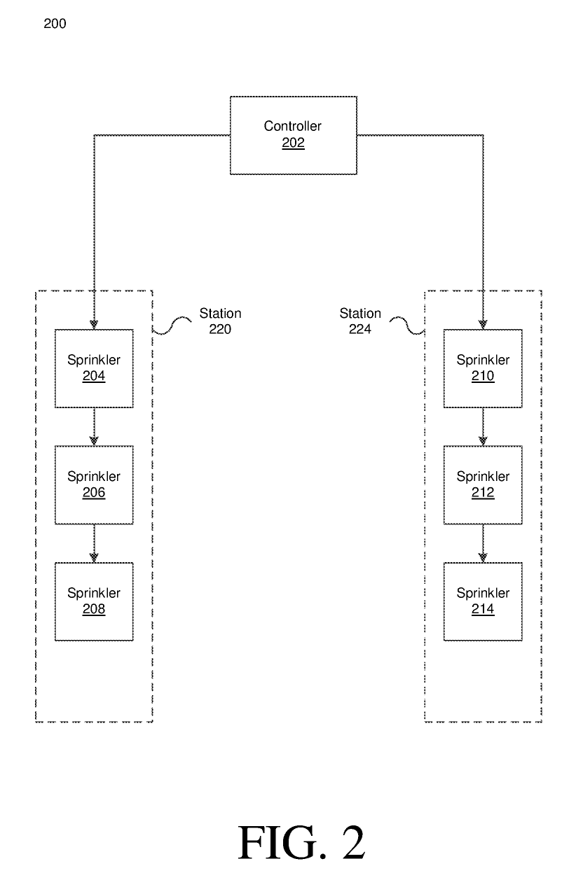

FIG. 2 illustrates a controller 202 for a watering system 200 (which may equate to the watering system 110, 112, 114 of FIG. 1). The watering system 200 is a simplified representation of an irrigation system that may benefit from watering management services. A typical irrigation system will include more stations and sprinklers than those shown. In the illustrated embodiment, the watering system 200 includes a controller 202 and stations 220 and 224. The station 220 contains sprinklers 204-208, and the station 224 contains sprinklers 210-214. The term “sprinkler” is used broadly to encompass a wide range of water distribution elements within a station such as pop-ups, bubblers, soaker hose, and other varieties of sprinkler heads and water distribution elements. The controller 202 may separately control each station 220 and 224. In a typical embodiment, the controller 202 will water the area associated with the station 220 at a first time, and the area associated with the station 224 at a second time. The controller 202 will typically cycle through the stations in the watering system 200 until the watering cycle is complete. As noted above, the stations 220 and 224 may each be associated with different areas of the property, and may serve areas with different needs. For example, the station 220 may be for a flower bed while the station 224 is for grass on a hillside.

In one embodiment, an irrigation manager may install a watering system based on information the irrigation manager obtains from visiting the property and analyzing current water usage and patterns set by the controller 202. The irrigation manager may also identify one or more characteristics of the property that affect water usage on the property. For example, the irrigation manager may note the plant material being watered by each station 220, 224 (whether flowers, shrubs, grass, or other), the soil composition at the first property and/or at the individual areas served by the stations 220, 224, and the climate at the first property. For example, the irrigation manager may note that the climate is arid if the property is located in a desert location. Other examples of characteristics the irrigation manager may note include the slope of the area associated with each station, the degree of exposure to sun and heat, and the health of the plant material under the current water application system.

In other embodiments, the watering system 200 may also include sensors that detect and collect irrigation-related data. The watering system 200 may include, for example, temperature sensors, moisture sensors, rain sensors, and others. The sensors may communicate the data they collect to the controller 202. The controller 202 may send this sensor data to the cloud based platform 102.

The controller 202 may execute the irrigation management plan from the cloud based platform 102, which irrigation management plan is individualized to the location of the irrigation system 200. As explained below, the fee charged to the user may be determined by estimating the water cost savings over a predetermined period of time (such as a year or an N-month period corresponding to the irrigation season), allocating between two-thirds and one-third of the estimated water cost savings over the predetermined period of time to the client, and setting the fee equal to the remaining water costs savings over the predetermined period of time. Alternatively, a monthly subscription fee for use of the cloud based platform 102 may be determined by the number of controllers, users, watering systems or other factors.

The cloud based platform 102 may receive the water usage data from the controller 202 and detect one or more faults in the irrigation system 200 using that water usage data. The software of cloud based platform 102 may execute one or more user-defined tests to diagnose the faults in the watering system 200. The software of cloud based platform 102 may run through a series of diagnostics to confirm that a fault exists, and then a series of program executions determining the fault type (i.e., what has failed to cause the fault). For example, if during watering the controller 202 reports excess water flow, the cloud based platform 102 may stop all watering at the stations and continue to monitor the flow. If a flow is detected even when all watering is stopped, the test may indicate that the fault type is a break in the pipe. If no flow is detected, the cloud based platform 102 may water each station at one-minute intervals and monitor the water usage by each station to identify which stations have a fault causing the excess water flow. Other tests for diagnosing faults in the watering system 200 may also be used. The cloud based platform 102 may also notify a user of the faults or a technician based on the settings the user prescribes, which may allow the technician to be dispatched to repair the faults or the user to repair them he or herself. The software of the cloud based platform 102 may also execute programs to determine the amount of water actually lost by the fault and the amount of water likely to be lost due to the fault.

In certain embodiments, the cloud based platform 102 may be configured to automatically retrieve water usage information for the watering system 200 as recorded by the relevant water authority. For example, the software may instruct the cloud based platform 102 to retrieve water usage information from a website for the local water authority. The client may be required to provide the cloud based platform 102 with appropriate credentials to allow the cloud based platform 102 to access the client's water usage information. In another embodiment, the irrigation manager may manually enter the water usage information as provided by the local water authority. The software within the cloud based platform 102 may execute a program comparing the water usage information as reported by the water authority with the water usage information reported by the controller 202. If the reported water usage information differs by a threshold amount, the cloud based platform 102 may provide an alert, notification or report to the user or the irrigation manager who may further calibrate the controller 202 and water usage measurement tools at the irrigation site 200, if necessary.

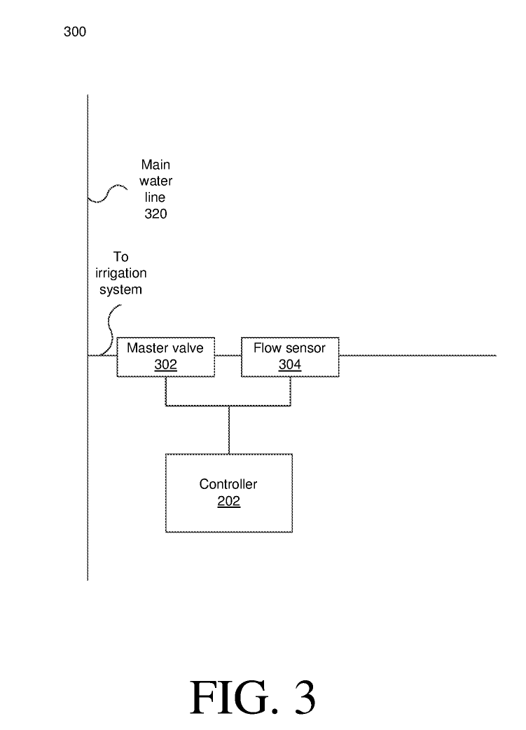

FIG. 3 illustrates a system 300 that is a simplified representation of a main water line 320 from which the watering system receives water. In one embodiment, the irrigation manager may install a master valve 302 at the main water line 320 and a flow sensor 304. The irrigation manager may install the master valve 302 between the main water line 320 servicing the property and the irrigation system itself. The irrigation manager may also communicatively connect the master valve 302 with the controller 202 such that the controller 202 can open and close the master valve 302, thus restricting and allowing flow from the main water line 320 into the watering system. In one embodiment, the irrigation manager also installs a flow sensor 304 and communicatively connects the flow sensor 304 with the controller 202. The flow sensor 304 may also be installed between the main water line 320 and the irrigation system. In certain embodiments, a plurality of flow sensors 304 may be distributed at various locations within the watering system including between each station of the watering systems or any number of sprinklers, including each sprinkler.

While FIG. 3 illustrates a master valve 302 and a flow sensor 304 as separate elements, in certain embodiments, the master valve 302 and the flow sensor 304 may be realized as part of the same unit. The system may also include a backflow preventer to prevent water from flowing out of the irrigation system and into the main water line 320.

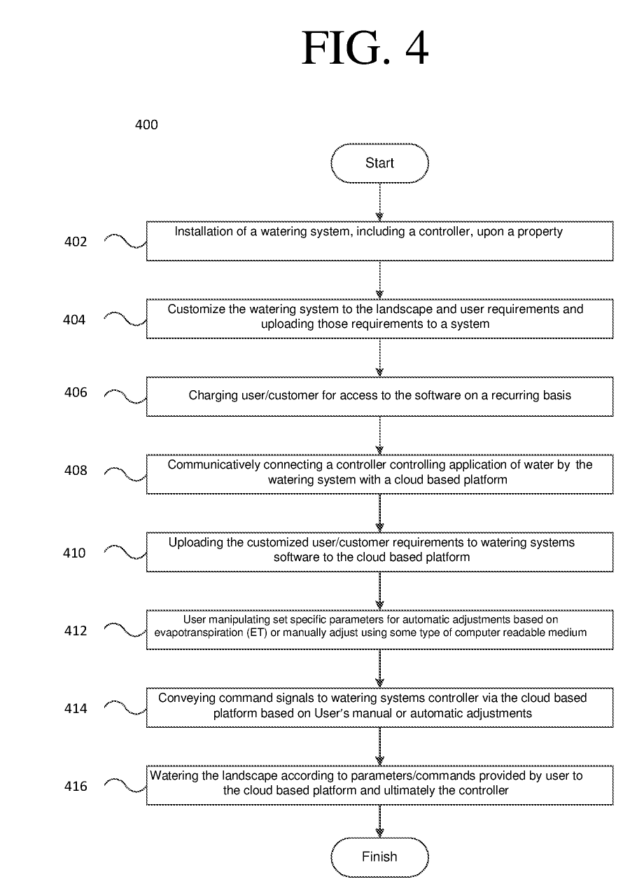

FIG. 4 illustrates one embodiment of a method 400 for providing irrigation management services. The method 400 may begin, at reference numeral 402, with installation of a watering system and identifying one or more characteristics of the first property that affect water usage on the first property. As noted above, examples of such characteristics include, but are not limited to, plant material at the site, soil composition, climate, exposure to sun, slope and other characteristics.

The method may also involve, at reference numeral 404, developing an irrigation management plan for the property using the one or more characteristics. The irrigation management plan specifies how much water is to be applied and the manner in which the water is applied. The irrigation management plan may tailor water application to the characteristics of the individual stations of the irrigation system. Thus, for example, a station watering an area located on a hill may water in 5 minute intervals to allow the water to sufficiently soak in without losing water to run off caused by saturation, while a flower bed may be watered for a ten-minute period with no intervals.

In certain embodiments, the irrigation manager may make changes to the stations conducive to implementing the irrigation management plan. For example, the irrigation manager may swap out a first sprinkler head for a second sprinkler head with a different flow rate, add or remove sprinkler heads from the irrigation system, and make other appropriate changes to maximize the effectiveness of the irrigation management plan. These customizations may then be uploaded to the watering system on the cloud based platform 102.

The method may include, at reference numeral 406, which includes determining the value of the irrigation management services and charging the user to access the cloud based platform 102 and the ability to manipulate the watering system via the cloud based platform 102. In one embodiment, this is done according by analyzing water usage, number of stations, number of properties, number of sprinklers number of systems, etc.

The method may include, at reference numeral 408, communicatively connecting the controller that controls application of water by the irrigation system with the cloud based platform 102 that is located off premises. The cloud based platform 102 may, for example, be located at the offices of the irrigation manager, in a server facility, or other location that is remote from the location of the irrigation system. The cloud based platform 102 may also be communicatively connected to a plurality of second controllers installed at a plurality of second properties that are owned by entities separate from the entity that owns the first property. The owners of the second properties may have also contracted with the irrigation manager for irrigation services. The irrigation manager may provide the above services to various separate property owners.

Once the cloud based platform 102 is communicatively connected to the controller, the method 400 may involve, at reference numeral 410, uploading the customized user requirements of the at least one watering system to the cloud based platform 102 which software on the cloud based platform then executes according to the user parameters set. In one embodiment, this involves the irrigation manager inputting the irrigation management plan that is customized for the property into the cloud based platform 102. The cloud based platform 102 may then communicate that irrigation management plan to the controller for the irrigation system installed at the first property. In one embodiment, the cloud based platform 102 transmits a schedule for irrigation which is received, stored, and implemented by the controller. The cloud based platform 102 may transmit changes to the irrigation management plan thereafter. In another embodiment, the cloud based platform 102 transmits individual commands that cause water to be applied according to the irrigation management plan, which commands are executed by the controller. For example, the cloud based platform 102 may send a command at 8:00 at night to water station one for ten minutes. In another embodiment, the cloud based platform transmits the schedule and maintains the ability to override the schedule with individual commands sent to the controller.

The method 400 may also involve, at reference numeral 412, allowing a user access to the cloud based platform 102 and the user manipulating the parameters of the watering system based on alerts, notifications, reports, budgets, or any other stipulation the user desires. Likewise the user may manually make adjustments during watering, after watering, before watering may make the adjustments permanent or automatic or may continue to manipulate the watering system with a schedule or no schedule.

The method 400 may also include, at reference numeral 414, conveying the signals entered by the irrigation manager or user to the watering systems controller via the cloud based platform 102. Access to that cloud based platform by the user may be by any of the electronic or manual means set forth previously herein.

The method 400 may include, at reference numeral 416, executing the signal from the cloud based platform thus watering the landscape according to the commands and parameters provided by the irrigation manager or user via the cloud based software accessed by any of the electronic or manual means set forth previously herein.

In one embodiment, the cloud based platform 102 sends one or more commands that shut the master valve 302, thus preventing flow of water from the main water line 320 into the watering system, in response to detecting a break in the pipe of the irrigation system. The cloud based platform 102 may be configured to send the commands automatically upon detecting a water usage data indicative of broken pipe. In other embodiments, a technician manually sends the commands to shut the master valve 302.

Where the fault is a broken component in one particular station of the irrigation system 200, the cloud based platform 102 may send one or more commands to the controller 202 causing the controller 202 not to distribute water using the station with the broken irrigation component. For example, if a station has a broken sprinkler head causing excess water to flow, the cloud based platform 102 may cause the controller 202 to continue implementing the irrigation management plan, but to skip the station with the broken sprinkler head. As above, modifying the irrigation management plan to stop watering from the station with the broken irrigation component may be automated, or may be manual manipulated by the user, by the cloud based platform 102, or such a modification to the irrigation management plan may be implemented by a technician or a user by accessing the cloud based platform 102 and informing the system to execute those commands.

In one embodiment, the irrigation manager may use technological means, such as a mobile application, to enter the irrigation management plan while on site. For example, the irrigation manager may, for each station in the irrigation system, enter a watering time and duration into the mobile application and input that information to the cloud based platform 102. Once the irrigation manager completes entry of the irrigation management plan, the application may transmit the irrigation management plan to the cloud based platform 102. The cloud based platform 102 may receive the irrigation management plan and save it for later execution and manipulation by a user.

Similarly, in one embodiment, the irrigation manager may set the irrigation management plan using the controller for the irrigation system. The irrigation manager may enter the watering time and duration, along with other aspects of the irrigation management plan into the controller. The irrigation manager may enter a code to cause the irrigation management plan to transmit to the cloud based platform 102 and to be saved by the cloud based platform 102 as the irrigation management plan for the watering system.

In one embodiment, the cloud based platform 102 is further configured to execute a pre-season test pattern at each irrigation system in communication with the cloud based platform 102. In such an embodiment, the cloud based platform 102 may, prior to the start of the season where irrigation is necessary, run tests on each station within each watering system to diagnose and identify problems according to user's parameters. For example, the cloud based platform 102 may cause each station to run for 30 seconds and monitor the water usage of each station. The cloud based platform 102 may generate a diagnostic report of problems detected during the testing. The irrigation manager or user may then go to the site to perform pre-season repairs and maintenance; however, the irrigation manager may be able to spend less time inspecting each sprinkler and/or station at the site since the irrigation manager or user will have already been notified of existing faults.

Although the foregoing description contains many specifics, these should not be construed as limiting the scope of the invention or of any of the appended claims, but merely as providing information pertinent to some specific embodiments that may fall within the scopes of the invention and the appended claims. Features from different embodiments may be employed in combination. In addition, other embodiments of the invention may also be devised which lie within the scopes of the invention and the appended claims. The scope of the invention is, therefore, indicated and limited only by the appended claims and their legal equivalents. All additions, deletions and modifications to the invention, as disclosed herein, that fall within the meaning and scopes of the claims are to be embraced by the claims.

1. A method for controlling a watering system comprising:
installing a watering system on a property;
customizing the watering system to the landscape of the property;
connecting a controller controlling the application of water by the watering system to a cloud based platform;
uploading the customized watering system requirements to the cloud based platform;
conveying command signals to the watering system controller from the cloud based platform;
executing command signals to the watering system controller immediately based on real-time feedback from the watering system;
communicating water usage from a relevant water authority with the watering system;
executing command signals to the watering system controller immediately based on real-time feedback from the relevant water authority; and
charging at least one user a recurring fee for access to the cloud based platform.

2. The method of claim 1, further comprising, accessing the cloud based platform via an electronic device wherein the electronic device comprises a tablet, a phone, a smartphone, a computer, or a laptop.

3. The method of claim 2, further comprising, manipulating the watering system by inputting commands to the cloud based platform via the electronic device.

4. The method of claim 2, further comprising, manipulating the watering system by inputting commands to the controller manually or by the electronic device.

5. The method of claim 2, further comprising, sending at least one command from the electronic device to the controller to manipulate the watering system.

6. The method of claim 5, wherein the user sends the at least one command to change watering duration.

7. The method of claim 5, wherein the user send the at least one command to change the watering times.

8. The method of claim 1, further comprising, monitoring the watering system with flow sensors installed throughout the watering system.

9. The method of claim 8, further comprising, sending an automatic command to the controller to shut down individual elements of the watering system in response to feedback from the flow sensors.

10. A method for controlling a watering system comprising:
installing a watering system on a property;
customizing the watering system to the landscape of the property;
connecting a controller controlling the application of water by the watering system to a cloud based platform;
uploading the customized watering system requirements to the cloud based platform;
conveying command signals to the watering system controller from the cloud based platform;
executing command signals to the watering system controller immediately based on real-time feedback from the watering system;
communicating water usage from a relevant water authority with the watering system;
executing command signals to the watering system controller immediately based on real-time feedback from the relevant water authority; and
watering the landscape in accordance with the command signals.

11. The method of claim 10, further comprising, charging a monthly user fee for a user to access the cloud based platform.

12. The method of claim 11, further comprising, accessing the cloud based platform via an electronic device wherein the electronic device comprises a tablet, a phone, a smartphone, a computer, or a laptop.

13. The method of claim 12, further comprising, manipulating the watering system by inputting commands to the cloud based platform via the electronic device.

14. The method of claim 10, further comprising, manipulating the watering system by inputting commands to the controller manually or by the electronic device.

15. A system for providing water management services, the system comprising:
a plurality of controllers, each controller controlling application of water by a watering system associated with the controller;
at least one first computer in communication with at least one of the plurality of controllers;
a cloud based platform in communication with the first computer and at least one second computer;
the cloud based platform in communication with a relevant water authority;
the cloud based platform in communication with at least one sensor in the watering system;
the cloud based platform configured to:
implement an irrigation management plan that is customized to a location and based, at least in part, upon one or more characteristics of the location;
execute command signals to the watering system controller immediately based on real-time feedback from the watering system and the relevant water authority; and
interact with a user, with the user able to manipulate the irrigation management plan.

16. The system of claim 15, wherein the at least one second computer comprises a computer, a tablet, a laptop, or a smartphone.

17. The system of claim 16, the at least one second comprising a user interface wherein the user may alter the irrigation management plan.

18. The system of claim 17, wherein the plurality of controllers react to a command provided by a user interacting with the at least one second computer, wherein the at least one second computer is remote from the at least one first computer.

19. The system of claim 18, further comprising, a computer readable medium storing instructions that when executed by a processor cause the processor to perform instructions, the instructions comprising:
receiving feedback from the at least one sensor of the watering system; and
controlling the plurality of controllers based on the feedback from -the at least one sensor.

20. The system of claim 18, further comprising, a computer readable medium storing instructions that when executed by a processor cause the processor to perform instructions, the instructions comprising:
receiving instructions from a user regarding the watering system; and
controlling the plurality of controllers based on the instructions provided by the user.
